(19) United States
(12) Patent Application Publication
(10) Pub. No.: US 2026/0011303 A1
(43) Pub. Date: Jan. 8, 2026

(54) PIXEL CIRCUIT, DISPLAY APPARATUS, AND DRIVING METHOD

(71) Applicants: Chengdu BOE Optoelectronics Technology Co., Ltd., Chengdu, Sichuan (CN); BOE Technology Group Co., Ltd., Beijing (CN)

(72) Inventors: Changbum PARK, Beijing (CN); Yongliang ZHAO, Beijing (CN)

(21) Appl. No.: 18/881,809

(22) PCT Filed: Mar. 13, 2024
(86) PCT No.: PCT/CN2024/081489

§ 371 Date: Jan. 7, 2025

(30) Foreign Application Priority Data
Apr. 27, 2023 (CN) 202310475149.4

(51) Int. Cl. G09G 3/3233; G09G 3/32

(52) U.S. Cl. CPC G09G 3/3233; G09G 3/32; G09G 2300/043; G09G 2300/0819; G09G 2310/08; G09G 2320/0233

(57) ABSTRACT

Disclosed are a pixel circuit, a display apparatus, and a driving method. The pixel circuit includes: a light-emitting device, a driving transistor, a driving control circuit and a conduction control circuit. The driving transistor is configured to generate, based on a data voltage signal, a driving current for driving the light-emitting device to emit light. The driving control circuit is coupled to the driving transistor, and is configured to provide the data voltage signal to a gate of the driving transistor and, in response to a signal from the light emission control signal terminal being at an active level, cause the driving transistor to generate the driving current. The conduction control circuit is configured to provide the driving current from the driving transistor to the light-emitting device in response to a signal from the first control signal terminal being at an active level.

### CROSS REFERENCE TO RELATED APPLICATIONS

The present application is a US National Stage of International Application No. PCT/CN2024/081489, filed on Mar. 13, 2024, which claims the priority from Chinese Patent Application No. 202310475149.4, filed with the China National Intellectual Property Administration on Apr. 27, 2023 and entitled “Pixel Circuit, Display Apparatus, and Driving Method”, which is hereby incorporated by reference in its entirety.

### TECHNICAL FIELD

The disclosure relates to the field of display technology, in particular to a pixel circuit, a display apparatus and a driving method.

### BACKGROUND

Organic Light Emitting Diodes (OLED), Quantum Dot Light Emitting Diodes (QLED), Micro Light Emitting Diodes (Micro LED), and Mini Light Emitting Diodes (Mini LED) are luminescent devices with advantages such as self-emission and low energy consumption. These technologies represent a key focus in the field of research and application for modern display devices. In general, display devices utilize pixel circuits to drive the luminescent devices for light emission.

### SUMMARY

A pixel circuit according to embodiments of the disclosure includes: a light-emitting device, a driving transistor, a driving control circuit and a conduction control circuit. The driving transistor is configured to generate, based on a data voltage signal, a driving current for driving the light-emitting device to emit light. The driving control circuit is coupled to the driving transistor, and is configured to provide the data voltage signal to a gate of the driving transistor and, in response to a signal from the light emission control signal terminal being at an active level, cause the driving transistor to generate the driving current. The driving transistor is coupled to the light-emitting device via the conduction control circuit, and the conduction control circuit is configured to provide the driving current from the driving transistor to the light-emitting device in response to a signal from the first control signal terminal being at an active level. Here, a duration of the active level of the signal from the first control signal terminal is shorter than a duration of the active level of the signal from the light emission control signal terminal.

In some possible implementations, the driving control circuit is configured to, in a light emission phase, in response to the signal from the light emission control signal terminal being at the active level, cause the driving transistor to generate the driving current. The conduction control circuit is configured to, in the light emission phase, in response to the signal from the first control signal terminal being at the active level, provide the driving current from the driving transistor to the light-emitting device. In the light emission phase, a start moment of the signal from the first control signal terminal being at the active level is later than a start moment of the signal from the light emission control signal terminal being at the active level. Or, a start moment of the signal from the first control signal terminal being at the active level is same as a start moment of the signal from the light emission control signal terminal being at the active level.

In some possible implementations, the driving control circuit includes: a reset circuit, a data writing circuit, a light emission control circuit, a first control circuit and a second control circuit. The reset circuit is coupled to a second terminal of the driving transistor, and is configured to provide a signal from the first reference voltage signal terminal to the second terminal of the driving transistor in response to a signal from a second control signal terminal. The data writing circuit is coupled to the gate of the driving transistor, and is configured to provide a reference voltage signal and a data voltage signal from a data signal terminal to the gate of the driving transistor, respectively. The light emission control circuit is coupled to the first terminal of the driving transistor, and is configured to provide a signal from a first power supply terminal to the first terminal of the driving transistor in response to the signal from the light emission control signal terminal. The first control circuit is coupled to the gate and second terminal of the driving transistor, and is configured to keep a voltage difference between the second terminal and the gate of the driving transistor stable. The second control circuit is coupled to the first power supply terminal and the second terminal of the driving transistor, and is configured to keep a voltage difference between the second terminal of the driving transistor and the first power supply terminal stable.

In some possible implementations, the data writing circuit is further configured to, in response to a signal from a third control signal terminal, first provide the reference voltage signal from the data signal terminal to the gate of the driving transistor and then provide the data voltage signal from the data signal terminal to the gate of the driving transistor.

In some possible implementations, the data writing circuit includes a first transistor. A gate of the first transistor is coupled to the third control signal terminal, a first terminal of the first transistor is coupled to the data signal terminal, and a second terminal of the first transistor is coupled to the gate of the driving transistor.

In some possible implementations, the data writing circuit is further configured to, in response to a signal from a third control signal terminal, provide the data voltage signal from the data signal terminal to the gate of the driving transistor, and in response to a signal from a fourth control signal terminal, provide the reference voltage signal from the data signal terminal to the gate of the driving transistor.

In some possible implementations, the data writing circuit includes a second transistor and a third transistor. A gate of the second transistor is coupled to the third control signal terminal, a first terminal of the second transistor is coupled to the data signal terminal, and a second terminal of the second transistor is coupled to the gate of the driving transistor. A gate of the third transistor is coupled to the fourth control signal terminal, a first terminal of the third transistor is coupled to the data signal terminal, and a second terminal of the third transistor is coupled to the gate of the driving transistor.

In some possible implementations, the reset circuit includes a fourth transistor.

A gate of the fourth transistor is coupled to the second control signal terminal, a first terminal of the fourth transistor is coupled to the second terminal of the driving transistor, and a second terminal of the fourth transistor is coupled to the first reference voltage signal terminal.

In some possible implementations, the light emission control circuit includes a fifth transistor. A gate of the fifth transistor is coupled to the light emission control signal terminal, a first terminal of the fifth transistor is coupled to the first power supply terminal, and a second terminal of the fifth transistor is coupled to the first terminal of the driving transistor.

In some possible implementations, the first control circuit includes a first capacitor. A first electrode of the first capacitor is coupled to the gate of the driving transistor, and a second electrode of the first capacitor is coupled to the second terminal of the driving transistor.

In some possible implementations, the second control circuit includes a second capacitor. A first electrode of the second capacitor is coupled to the first power supply terminal, and a second electrode of the second capacitor is coupled to the second terminal of the driving transistor.

In some possible implementations, the conduction control circuit includes a sixth transistor. A gate of the sixth transistor is coupled to the first control signal terminal, a first terminal of the sixth transistor is coupled to the second terminal of the driving transistor, and a second terminal of the sixth transistor is coupled to the light-emitting device.

In some possible implementations, the driving transistor is a single-gate transistor.

In some possible implementations, the driving transistor is a dual-gate transistor, where the driving transistor includes a top gate and a bottom gate. The top gate is coupled to the data writing circuit, and the bottom gate is coupled to the second terminal of the driving transistor.

Embodiments of the disclosure provide a display apparatus. The display apparatus includes the above-described pixel circuit.

Embodiments of the disclosure provide a driving method for the above pixel circuit. The method includes: in a data writing phase, the driving control circuit providing the data voltage signal to the gate of the driving transistor; and in a light emission phase, the driving control circuit, in response to the signal from the light emission control signal terminal being at the active level, causing the driving transistor to generate the driving current, and the conduction control circuit, in response to the signal from the first control signal terminal being at the active level, providing the driving current from the driving transistor to the light-emitting device.

### BRIEF DESCRIPTION OF FIGURES

FIG. 1 shows a schematic diagram of some structures of a pixel circuit according to embodiments of the disclosure.

FIG. 2 shows another schematic diagram of some structures of a pixel circuit according to embodiments of the disclosure.

FIG. 3 shows another schematic diagram of some structures of a pixel circuit according to embodiments of the disclosure.

FIG. 4 shows a signal timing chart according to embodiments of the disclosure.

FIG. 5 shows another signal timing chart according to embodiments of the disclosure.

FIG. 6 shows a flowchart of a driving method of a pixel circuit according to embodiments of the disclosure.

FIG. 7 shows another schematic diagram of some structures of a pixel circuit according to embodiments of the disclosure.

FIG. 8 shows another schematic diagram of some structures of a pixel circuit according to embodiments of the disclosure.

FIG. 9 shows another signal timing chart according to embodiments of the disclosure.

FIG. 10 shows another signal timing chart according to embodiments of the disclosure.

### DETAILED DESCRIPTION

In order to make objectives, technical solutions and advantages of the embodiments of the disclosure clearer, the technical solutions of the embodiments of the disclosure are described clearly and completely below with reference to the drawings of the embodiments of the disclosure. Apparently, the described embodiments are some, not all, of the embodiments of the disclosure. The embodiments in the disclosure and the features in the embodiments may be combined with each other without conflict. Based on the described embodiments of the disclosure, all other embodiments obtained by those of ordinary skill in the art without inventive efforts fall within the protection scope of the disclosure.

Unless otherwise indicated, the technical or scientific terms used in the disclosure shall have the usual meanings understood by a person of ordinary skill in the art to which the disclosure belongs. The words “first”, “second” and the like used in the disclosure do not indicate any order, quantity or importance, but are only used to distinguish different components. The word “including” or “containing” and the like, means that an element or item preceding the word covers an element or item listed after the word and the equivalent thereof, without excluding other elements or items. The word “connection” or “coupling” and the like is not restricted to physical or mechanical connection, but may include electrical connection, whether direct or indirect.

It should be noted that sizes and shapes of all figures in the drawings do not reflect a true scale and are only intended to illustrate the contents of the disclosure. Same or similar reference signs indicate same or similar elements or elements with the same or similar function throughout the disclosure.

The display apparatus according to embodiments of the disclosure includes: a display panel, where the display panel includes a plurality of pixel units arranged in an array in a display region. For example, each pixel unit includes multiple sub-pixels. In some embodiments, a pixel unit can include red, green, and blue sub-pixels, which can be mixed to achieve color display. Alternatively, a pixel unit may include red, green, blue, and white sub-pixels, allowing for color mixing through red, green, blue, and white to achieve color display. Of course, in practical applications, the emission color of the sub-pixels in the pixel unit can be designed and determined according to the specific application environment, and this is not intended to be restrictive.

In embodiments of the disclosure, each sub-pixel includes a pixel circuit, where the pixel circuit includes a driving transistor and a light-emitting device to drive the light-emitting device to emit light, thereby enabling the display panel to display images. Due to factors such as manufacturing processes and device aging, threshold voltages Vth of the driving transistors may exhibit non-uniformity, leading to the current flowing through different light-emitting devices varying, causing uneven display brightness and affecting the overall image quality.

Additionally, the non-uniformity of the parasitic capacitances Coled of the light-emitting devices L (i.e., the capacitance formed by the cathode and anode of the light-emitting device L) can also affect the display effect and lead to a decline in display quality.

The following describes the disclosure in detail with reference to specific embodiments. It should be noted that the embodiments are provided to better explain the disclosure, but are not intended to limit it.

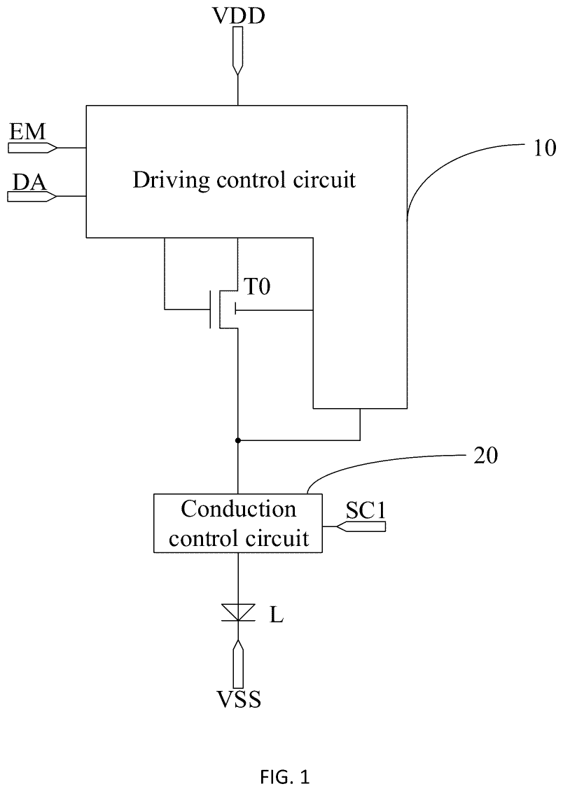

The pixel circuit according to embodiments of the disclosure, as shown in FIG. 1, includes: a light-emitting device L, a driving transistor T0, and a conduction control circuit 20.

The driving transistor T0 is configured to generate a driving current for driving the light-emitting device L to emit light based on a data voltage signal.

The driving control circuit 10 is coupled to the driving transistor T0, and is configured to, in response to a signal from a light emission control signal terminal EM being at an active level, provide the data voltage signal to a gate of the driving transistor T0 to cause the driving transistor T0 to generate the driving current.

The driving transistor T0 is coupled to the light-emitting device L via the conduction control circuit 20. The conduction control circuit 20 is configured to, in response to a signal from a first control signal terminal SC1 being at an active level, provide the driving current from the driving transistor T0 to the light-emitting device L.

Here, a duration of the active level of the signal from the first control signal terminal SC1 is shorter than a duration of the active level of the signal from the light emission control signal terminal EM.

Based on the disclosure, voltage fluctuations caused by the non-uniform parasitic capacitances Coled of the light-emitting devices L can be reduced by the cooperation between the driving control circuit and the conduction control circuit. This helps reduce brightness differences between the sub-pixels caused by voltage fluctuations, thereby improving the display effect of the display panel. Additionally, by providing the conduction control circuit, the signal from the first control signal terminal and the data voltage signal will not be affected by the limitation of the light-emitting voltage of the light-emitting device, thus expanding the driving range.

In embodiments of the disclosure, as shown in FIG. 1, the driving transistor T0 can be an N-type transistor. Here, a first terminal of the driving transistor T0 can serve as a source, and a second terminal can serve as a drain. Of course, the driving transistor T0 can also be a P-type transistor, which is not limited here.

In embodiments of the disclosure, as shown in FIG. 1, the second terminal of the driving transistor T0 is coupled to an anode of the light-emitting device L via the conduction control circuit 20, and a cathode of the light-emitting device L is coupled to a second power supply terminal VSS. In some embodiments, the light-emitting device L can include at least one of: a micro light-emitting diode (Micro LED), an organic light-emitting diode (OLED), or a quantum dot light-emitting diode (QLED). For example, the light-emitting device L may include an anode, a light-emitting layer, and a cathode arranged in a stack. Furthermore, the light-emitting layer can include various films such as a hole injection layer, a hole transport layer, an electron transport layer, and an electron injection layer. In practical applications, the specific structure of the light-emitting device can be designed and determined according to the actual application environment, which is not limited here.

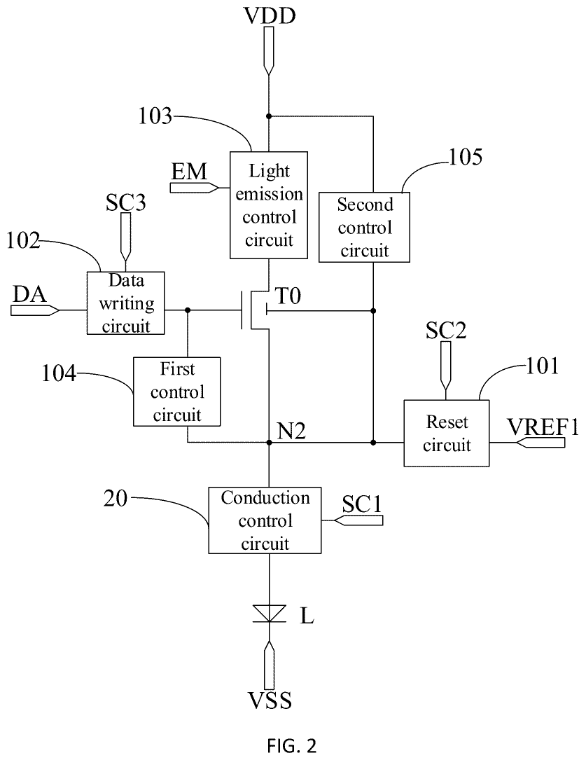

In some embodiments of the disclosure, as shown in FIG. 2, the driving control circuit 10 includes: a reset circuit 101, a data writing circuit 102, a light emission control circuit 103, a first control circuit 104, and a second control circuit 105.

The reset circuit 101 is coupled to the second terminal of the driving transistor T0, and is configured to, in response to a signal from the second control signal terminal SC2, provide a signal from a first reference voltage terminal VREF1 to the second terminal of the driving transistor T0.

The data writing circuit 102 is coupled to the gate of the driving transistor T0, and is configured to provide a reference voltage signal and the data voltage signal from the data signal terminal DA to the gate of the driving transistor T0, respectively.

The light emission control circuit 103 is coupled to the first terminal of the driving transistor T0, and is configured to, in response to the signal from the light emission control signal terminal EM, provide a signal from a first power supply terminal VDD to the first terminal of the driving transistor T0.

The first control circuit 104 is coupled to the gate and second terminal of the driving transistor T0, and is configured to maintain a voltage difference between the second terminal and the gate of the driving transistor T0 stable.

The second control circuit 105 is coupled to the first power supply terminal VDD and the second terminal of the driving transistor T0, and is configured to maintain a voltage difference between the second terminal and the first power supply terminal VDD stable.

In some embodiments of the disclosure, as shown in FIG. 2, the data writing circuit 102 is further configured to, in response to a signal from a third control signal terminal SC3, first provide the reference voltage signal from the data signal terminal DA to the gate of the driving transistor T0, and then provide the data voltage signal from the data signal terminal DA to the gate of the driving transistor T0.

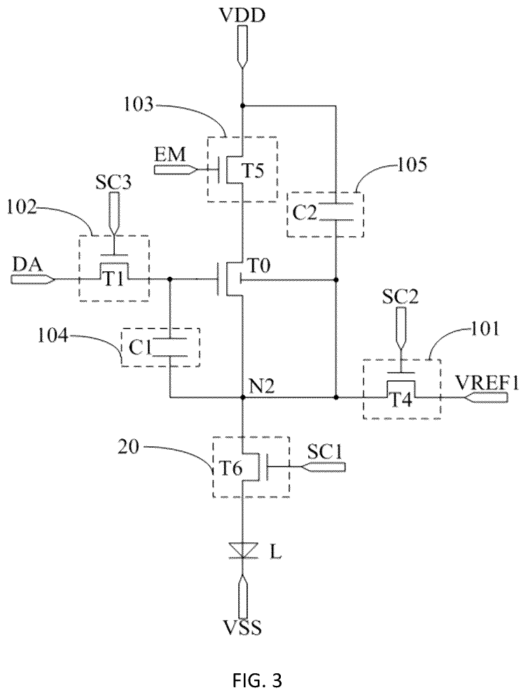

In some embodiments of the disclosure, as shown in FIG. 3, the data writing circuit 102 includes: a first transistor T1. A gate of the first transistor T1 is coupled to the third control signal terminal SC3, a first terminal of the first transistor T1 is coupled to the data signal terminal DA, and a second terminal of the first transistor T1 is coupled to the gate of the driving transistor T0.

In some embodiments, the first transistor T1 can be turned on under the control of a third control signal at an active level from the third control signal terminal SC3 and can be turned off under the control of the third control signal at an inactive level. In some embodiments, the first transistor T1 is a P-type transistor, the active level of the third control signal is a low level, and the inactive level of the third control signal is a high level. Alternatively, the first transistor T1 is an N-type transistor, the active level of the third control signal is a high level, and the inactive level of the third control signal is a low level.

In some embodiments of the disclosure, as shown in FIG. 3, the reset circuit 101 includes: a fourth transistor T4. A gate of the fourth transistor T4 is coupled to the second control signal terminal SC2, a first terminal of the fourth transistor T4 is coupled to the second terminal of the driving transistor T0, and a second terminal of the fourth transistor T4 is coupled to the first reference voltage signal terminal VREF1.

In some embodiments, the fourth transistor T4 can be turned on under the control of the second control signal at the active level from the second control signal terminal SC2 and can be turned off under the control of the second control signal at the active level. For example, the fourth transistor T4 is a P-type transistor, the active level of the second control signal is a low level, and the inactive level of the second control signal is a high level. Alternatively, the fourth transistor T4 is an N-type transistor, the active level of the second control signal is a high level, and the inactive level of the second control signal is a low level.

In some embodiments of the disclosure, as shown in FIG. 3, the light emission control circuit 103 includes: a fifth transistor T5. A gate of the fifth transistor T5 is coupled to the light emission control signal terminal EM, a first terminal of the fifth transistor T5 is coupled to the first power supply terminal VDD, and a second terminal of the fifth transistor T5 is coupled to the first terminal of the driving transistor T0.

In some embodiments, the fifth transistor T5 can be turned on under the control of the light emission control signal at the active level from the light emission control signal terminal EM and can be turned off under the control of the light emission control signal at the inactive level. In some embodiments, the fifth transistor T5 is a P-type transistor, the active level of the light emission control signal is a low level, and the inactive level of the light emission control signal is a high level. Alternatively, the fifth transistor T5 is an N-type transistor, the active level of the light emission control signal is a high level, and the inactive level of the light emission control signal is a low level.

In some embodiments of the disclosure, as shown in FIG. 3, the first control circuit 104 includes: a first capacitor C1. A first electrode of the first capacitor C1 is coupled to the gate of the driving transistor T0, and a second electrode of the first capacitor C1 is coupled to the second terminal of the driving transistor T0.

In some embodiments of the disclosure, as shown in FIG. 3, the second control circuit 105 includes: a second capacitor C2. A first electrode of the second capacitor C2 is coupled to the first power supply terminal VDD, and a second electrode of the second capacitor C2 is coupled to the second terminal of the driving transistor T0.

In some embodiments of the disclosure, as shown in FIG. 3, the conduction control circuit 20 includes: a sixth transistor T6. A gate of the sixth transistor T6 is coupled to the first control signal terminal SC1, a first terminal of the sixth transistor T6 is coupled to the second terminal of the driving transistor T0, and a second terminal of the sixth transistor T6 is coupled to the light-emitting device L.

In some embodiments, the sixth transistor T6 can be turned on under the control of the first control signal at the active level from the first control signal terminal SC1 and can be turned off under the control of the first control signal at the inactive level. In some embodiments, the sixth transistor T6 is an N-type transistor, the active level of the first control signal is a high level, and the inactive level of the first control signal is a low level. Alternatively, the sixth transistor T6 is a P-type transistor, the active level of the first control signal is a low level, and the inactive level of the first control signal is a high level.

In some embodiments of the disclosure, as shown in FIG. 3, the driving transistor T0 is a double-gate transistor. The driving transistor T0 includes: a top gate and a bottom gate. The top gate is coupled to the data writing circuit 102, and the bottom gate is coupled to the second terminal of the driving transistor T0.

In some embodiments, the first terminal of the above transistors can be their source, and the second terminal can be their drain. Alternatively, the first terminal can be their drain, and the second terminal can be their source. This is not limited in the disclosure.

Typically, transistors with the active layer using low-temperature polysilicon (LTPS) material have a high mobility, and can be made thinner, smaller, and lower in power consumption. In specific implementations, the material of the active layer of at least one of the above transistors can adopt low-temperature polysilicon material. As such, the above transistor can be an LTPS-type transistor, to allow the pixel circuit to have high mobility and smaller size with lower power consumption.

Typically, transistors with metal oxide semiconductor materials used for the active layer have a smaller leakage current. Therefore, to reduce leakage current, in some embodiments of the disclosure, the material of the active layer of at least one of the above transistors may include metal oxide semiconductor materials, such as IGZO (Indium Gallium Zinc Oxide), or other metal oxide semiconductor materials. This allows the above transistor to be set as an oxide thin-film transistor (OTFT) to reduce the leakage current of the pixel circuit.

For example, all transistors can be LTPS-type transistors.

Alternatively, all transistors can be oxide-type transistors since metal oxides are relatively inexpensive and do not require laser equipment for crystallization.

Alternatively, some transistors can be oxide-type transistors, while others can be LTPS-type transistors.

In embodiments of the disclosure, the first power supply terminal VDD can be provided with a constant first power supply voltage vdd, and the first power supply voltage vdd is generally positive. Additionally, the second power supply terminal VSS can be provided with a constant second power supply voltage vss, and the second power supply voltage vss can generally be a ground voltage or negative value. In practical applications, the specific values of the first power supply voltage vdd and the second power supply voltage vss can be designed and determined based on the actual application environment, which is not limited here.

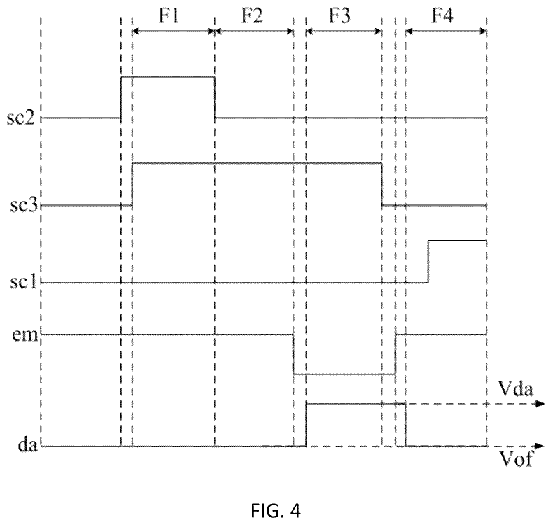

In some embodiments of the disclosure, the driving control circuit is configured to, in a light emission phase, in response to the signal from the light emission control signal terminal being at the active level, cause the driving transistor to generate the driving current. The conduction control circuit is configured to, in the light emission phase, provide the driving current from the driving transistor T0 to the light-emitting device L, in response to the signal from the first control signal terminal being at the active level. For example, as shown in FIGS. 1 and 4, the driving control circuit 10 is configured to, in the light emission phase F4, generate the driving current in response to the high-level signal from the light emission control signal terminal EM. The conduction control circuit 20 is configured to, in the light emission phase, provide the driving current from the driving transistor T0 to the light-emitting device L, in response to the high-level signal from the first control signal terminal SC1.

In some embodiments of the disclosure, in the light emission phase, a start moment the signal from the first control signal terminal being at the active level is after a start moment of the signal from the light emission control signal terminal being at the active level. For example, as shown in FIG. 4, in the light emission phase F4, the start moment of the high-level signal from the first control signal terminal SC1 is after the start moment of the high-level signal from the light emission control signal terminal EM.

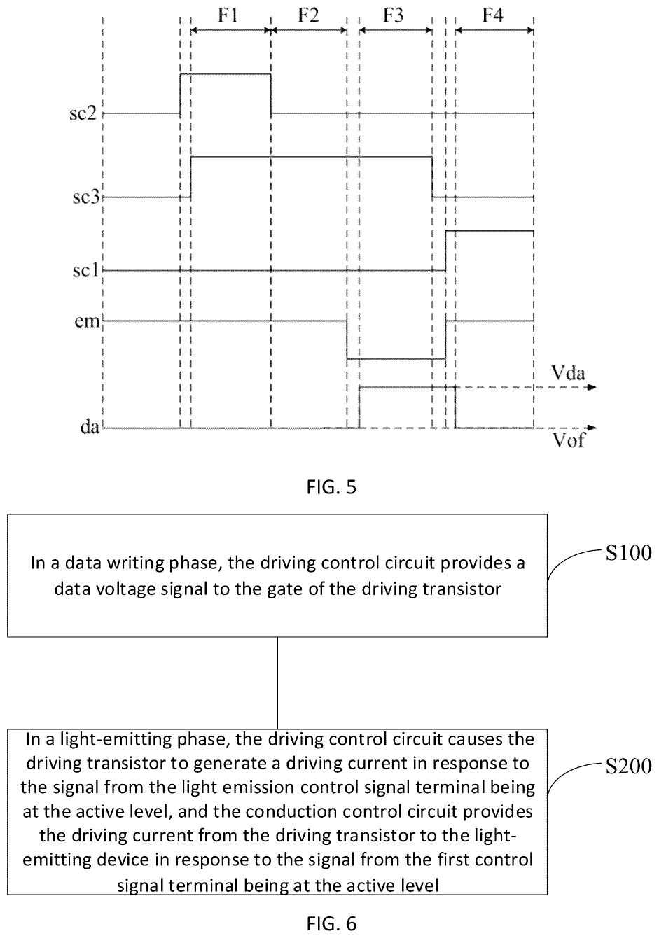

In some embodiments of the disclosure, in the light emission phase, the start moment of the signal from the first control signal terminal being at the active level is the same as the start moment of the signal from the light emission control signal terminal being at the active level. For example, as shown in FIG. 5, the start moment of the high-level signal from the first control signal terminal SC1 is the same as the start moment of the high-level signal from the light emission control signal terminal EM.

The driving method of the pixel circuit provided in the embodiments of the disclosure is shown in FIG. 6 and includes the following steps:
S100: in a data writing phase, the driving control circuit provides a data voltage signal to the gate of the driving transistor;
S200: in a light-emitting phase, the driving control circuit causes the driving transistor to generate a driving current in response to the signal from the light emission control signal terminal being at the active level, and the conduction control circuit provides the driving current from the driving transistor to the light-emitting device in response to the signal from the first control signal terminal being at the active level.

Before the data writing phase, a reset phase and a threshold compensation phase are also included. In the reset phase, the reset circuit, in response to the signal from a second control signal terminal, provides a signal from the first reference voltage signal terminal to the second terminal of the driving transistor; the data writing circuit provides a reference voltage signal from the data signal terminal to the gate of the driving transistor; and the light emission control circuit, in response to the signal from the light emission control signal terminal, provides a signal from the first power supply terminal to the first terminal of the driving transistor. In the threshold compensation phase, the data writing circuit provides the reference voltage signal from the data signal terminal to the gate of the driving transistor; the light emission control circuit, in response to the signal from the light emission control signal terminal, provides a signal from the first power supply terminal to the first terminal of the driving transistor.

Taking the pixel circuit shown in FIG. 3 as an example, and combining the signal timing charts shown in FIGS. 4 and 5, a working process of the pixel circuit provided in the embodiments of the disclosure will be described below.

In the embodiments of the disclosure, as shown in FIGS. 4 and 5, reference sign em indicates the light emission control signal from the light emission control signal terminal EM, reference sign sc1 indicates the first control signal from the first control signal terminal SC1, reference sign sc2 indicates the second control signal from the second control signal terminal SC2, reference sign sc3 indicates the third control signal from the third control signal terminal SC3, and reference sign da indicates the signal from the data signal terminal DA.

Furthermore, a reset phase F1, a threshold compensation phase F2, a data writing phase F3, and a light emission phase F4 in a display frame are selected.

In the reset phase F1, the first transistor T1 is turned on under control of the high-level third control signal sc3, the fourth transistor T4 is turned on under control of the high-level second control signal sc2, the fifth transistor T5 is turned on under control of the high-level light emission control signal em, and the sixth transistor T6 is turned off under control of the low-level first control signal sc1. The fifth transistor T5 being turned on provides a signal from the first power supply terminal VDD to the first terminal of the driving transistor T0. The first transistor T1 being turned on provides a reference voltage signal from the data signal terminal DA to the gate of the driving transistor T0. The voltage of the reference voltage signal is Vof, so the voltage at the gate of the driving transistor T0 is Vof. The fourth transistor T4 being turned on provides a signal from the first reference voltage signal terminal VREF1 to the second terminal of the driving transistor T0, resetting the second terminal of the driving transistor T0, where the voltage at the first reference voltage signal terminal VREF1 is Vref1.

In the threshold compensation phase F2, the first transistor T1 is turned on under control of the high-level third control signal sc3, the fourth transistor T4 is turned off under control of the low-level second control signal sc2, the fifth transistor T5 is turned on under control of the high-level light emission control signal em, and the sixth transistor T6 is turned off under control of the low-level first control signal sc1. The fifth transistor T5 being turned on provides a signal from the first power supply terminal VDD to the first terminal of the driving transistor T0. The first transistor T1 being turned on provides a reference voltage signal from the data signal terminal DA to the gate of the driving transistor T0, and the voltage at the gate of the driving transistor T0 is Vof. The threshold voltage of the driving transistor T0 is compensated, based on the first capacitor C1 and the second capacitor C2, as well as a source follower method. The voltage at the second terminal of the driving transistor T0 becomes Vof-Vth, and the driving transistor T0 turns off, where Vth represents the threshold voltage of the driving transistor T0.

In the data writing phase F3, the first transistor T1 is turned on under control of the high-level third control signal sc3, the fourth transistor T4 is turned off under control of the low-level second control signal sc2, the fifth transistor T5 is turned off under control of the low-level light emission control signal em, and the sixth transistor T6 is turned off under control of the low-level first control signal sc1. The first transistor T1 being turned on provides a data voltage signal from the data signal terminal DA to the gate of the driving transistor T0. The voltage of the data voltage signal is Vda, so the voltage at the gate of the driving transistor T0 is Vda. The first capacitor C1 keeps the voltage difference between the second terminal of the driving transistor T0 and the gate of the driving transistor T0 stable. The second capacitor C2 keeps the voltage difference between the second terminal of the driving transistor T0 and the first power supply terminal VDD stable. Thus, the voltage at the second terminal of the driving transistor T0 changes from Vof-vth to

$$Vof - Vth + \frac{C 1}{C 1 + C 2} * ( Vda - Vof ) .$$

When considering the parasitic capacitance Coled of the light-emitting device L, the voltage at the second terminal of the driving transistor T0 becomes

$$Vof - Vth + \frac{C 1}{C 1 + C 2 + Coled} * ( Vda - Vof ) ,$$

where C1 indicated the capacitance value of the first capacitor C1, C2 indicates the capacitance value of the second capacitor C2, and Coled indicates the parasitic capacitance of the light-emitting device L.

In the light emission phase F4, the first transistor T1 is turned off under control of the low-level third control signal sc3, the fourth transistor T4 is turned off under control of the low-level second control signal sc2, the fifth transistor T5 is turned on under control of the high-level light emission control signal em, and the sixth transistor T6 is turned on under control of the high-level first control signal sc1. The turned-on fifth transistor T5 provides the signal from the first power terminal VDD to the first terminal of the driving transistor T0, causing the driving transistor T0 to generate a drive current. The turned-on sixth transistor T6 provides the driving current from the driving transistor T0 to the light-emitting device L, and this driving current charges the anode of the light-emitting device L until the light-emitting device L stabilizes its emission. The voltage difference Vgs between the gate and source of the driving transistor T0 is

$$\frac{C 2}{C 1 + C 2} * ( Vda - Vof ) + Vth .$$

The driving transistor T0 operates in saturation, and the driving current it generates is

$$I = \frac{1}{2} * k * {[ \frac{C 2}{C 1 + C 2} * ( Vda - Vof ) ]}^{2} , where k = μ {C}_{ox} \frac{W}{L} ,$$

where μ indicates the mobility of the driving transistor T0, Cox indicates the capacitance per unit area of the gate insulation layer of the driving transistor T0, and W/L indicates the width-to-length ratio of the channel of the driving transistor T0. When considering the parasitic capacitance Coled of the light-emitting device L, the driving current becomes

$$I = \frac{1}{2} * k * {[ \frac{C 2 + Coled}{C 1 + C 2 + Coled} * ( Vda - Vof ) ]}^{2} .$$

It should be noted that, in the light emission phase F4, if a turned-on moment of the sixth transistor T6 is earlier than a turned-on moment of the fifth transistor T5, coupling based on the parasitic capacitance Coled of the light-emitting device L will occur at the second terminal of the driving transistor T0. If there are differences in the capacitance values of the parasitic capacitances Coled, this may lead to slight brightness variations on the display panel, affecting the display effect and causing a decline in display quality.

In some embodiments of the disclosure, as shown in FIG. 5, by setting the start moment of the first control signal sc1 to be the same as the start moment of the light emission control signal em in the light emission phase F4, both the sixth transistor T6 and the fifth transistor T5 can be turned on simultaneously. This can avoid the coupling caused by the parasitic capacitance Coled of the light-emitting device L at the second terminal of the driving transistor T0, thus improving the uniformity of brightness and image quality on the display panel, enhancing the display effect.

Moreover, in some embodiments of the disclosure, as shown in FIG. 4, by setting the start moment of the first control signal sc1 to be later than the start moment of the light emission control signal em in the light emission phase F4, the turned-on moment of the sixth transistor T6 is later than that of the fifth transistor T5. For example, the sixth transistor T6 can be controlled to be turned on after the light emission control signal's voltage has risen to more than 80% of its high-level voltage (e.g., 85%, 90%, 95%, etc.). This can avoid coupling based on the parasitic capacitance Coled of the light-emitting device L at the second terminal of the driving transistor T0 and, compared to turning on the sixth transistor T6 simultaneously with the fifth transistor T5, further improves the brightness and image quality uniformity of the display panel, enhancing the display effect.

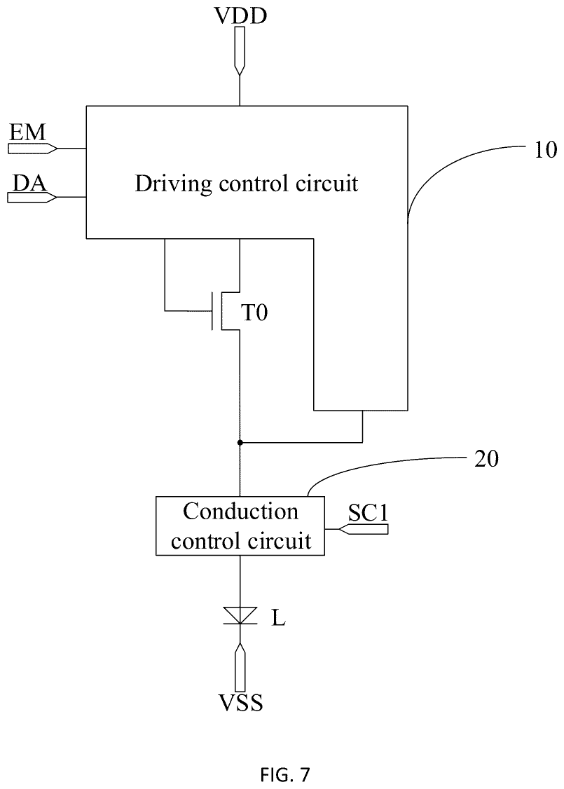

Embodiments of the disclosure also provide another structural diagram of the pixel circuit, as shown in FIG. 7, which modifies the implementations in the previous embodiments. Only the differences between this embodiment and the previous ones are described below, and the similar parts are not elaborated.

In some other embodiments of the disclosure, as shown in FIG. 7, the driving transistor T0 is a single-gate transistor.

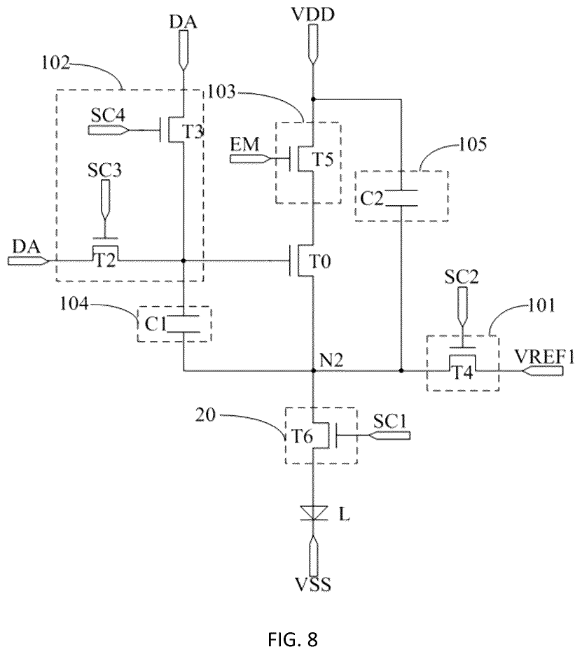

In some other embodiments of the disclosure, as shown in FIG. 8, the data writing circuit 102 is configured to, in response to the signal from the third control signal terminal SC3, provide the data voltage signal from the data signal terminal DA to the gate of the driving transistor T0, and in response to a signal from a fourth control signal terminal SC4, provide the reference voltage signal from the data signal terminal DA to the gate of the driving transistor T0.

In some other embodiments of the disclosure, as shown in FIG. 8, the data writing circuit 102 includes: a second transistor T2 and a third transistor T3. A gate of the second transistor T2 is coupled to the third control signal terminal SC3, a first terminal of the second transistor T2 is coupled to the data signal terminal DA, and a second terminal of the second transistor T2 is coupled to the gate of the driving transistor T0. A gate of the third transistor T3 is coupled to the fourth control signal terminal SC4, a first terminal of the third transistor T3 is coupled to the data signal terminal DA, and a second terminal of the third transistor T3 is coupled to the gate of the driving transistor T0.

For example, the second transistor T2 can be turned on under control of the third control signal from the third control signal terminal SC3 being at the active level, and turned off under control of the third control signal being inactive. For example, the second transistor T2 can be a P-type transistor, where the active level of the third control signal is a low level, and the inactive level is a high level. Alternatively, the second transistor T2 can be an N-type transistor, where the active level of the third control signal is a high level, and the inactive level is a low level.

In some embodiments, the third transistor T3 can be turned on under control of the fourth control signal from the fourth control signal terminal SC4 being at the active level, and turned off under control of the fourth control signal being inactive. For example, the third transistor T3 can be a P-type transistor, where the active level of the fourth control signal is a low level, and the inactive level is a high level. Alternatively, the third transistor T3 can be an N-type transistor, where the active level of the fourth control signal is a high level, and the inactive level is a low level.

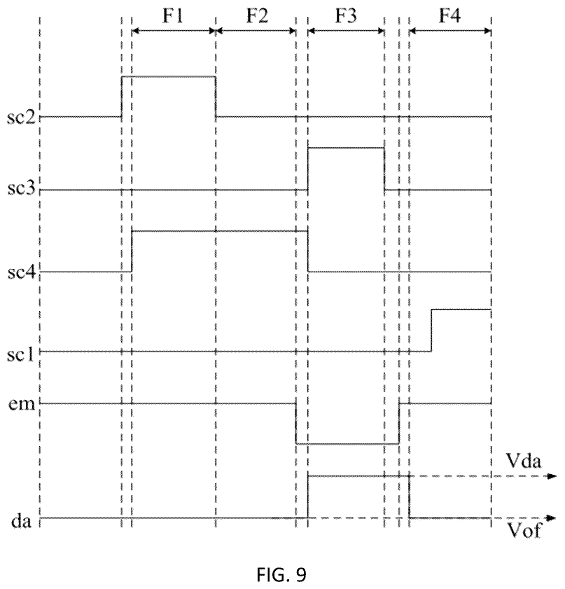

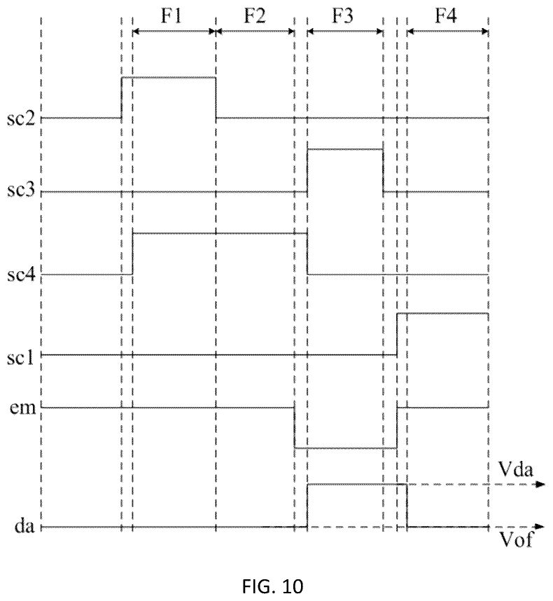

In embodiments of the disclosure, as shown in FIG. 9 and FIG. 10, reference sign em indicates the light emission control signal from the light emission control signal terminal EM, reference sign sc1 indicates the first control signal from the first control signal terminal SC1, reference sign sc2 indicates the second control signal from the second control signal terminal SC2, reference sign sc3 indicates the third control signal from the third control signal terminal SC3, reference sign sc4 indicates the fourth control signal from the fourth control signal terminal SC4, and reference sign da indicates the signal from the data signal terminal DA.

Furthermore, a reset phase F1, a threshold compensation phase F2, a data writing phase F3, and a light emission phase F4 are selected from a display frame.

In the reset phase F1, the second transistor T2 is turned off under control of the low-level third control signal sc3, the third transistor T3 is turned on under control of the high-level fourth control signal sc4, the fourth transistor T4 is turned on under control of the high-level second control signal sc2, the fifth transistor T5 is turned on under control of the high-level light emission control signal em, and the sixth transistor T6 is turned off under control of the low-level first control signal sc1. The turned-on fifth transistor T5 provides the signal from the first power terminal VDD to the first terminal of the driving transistor T0. The turned-on third transistor T3 provides the reference voltage signal from the data signal terminal DA to the gate of the driving transistor T0, so the voltage at the gate of the driving transistor T0 is Vof. The turned-on fourth transistor T4 provides the reference voltage signal from the first reference voltage terminal VREF1 to the second terminal of the driving transistor T0, resetting the second terminal of the driving transistor T0, where the voltage of the signal from the first reference voltage terminal VREF1 is Vref1.

In the threshold compensation phase F2, the second transistor T2 is turned off under control of the low-level third control signal sc3, the third transistor T3 is turned on under control of the high-level fourth control signal sc4, the fourth transistor T4 is turned off under control of the low-level the second control signal sc2, the fifth transistor T5 is turned on under control of the high-level light emission control signal em, and the sixth transistor T6 is turned off under control of the low-level first control signal sc1. The turned-on fifth transistor T5 provides the signal from the first power terminal VDD to the first terminal of the driving transistor T0. The turned-on third transistor T3 provides the reference voltage signal from the data signal terminal DA to the gate of the driving transistor T0, and the voltage at the gate of the driving transistor T0 is Vof. The threshold voltage of the driving transistor T0 can be compensated based on the first capacitor C1 and the second capacitor C2, as well as a source follower method. The driving transistor T0 is turned off when the voltage at its second terminal becomes Vof-Vth.

In the data writing phase F3, the second transistor T2 is turned on under control of the high-level third control signal sc3, the third transistor T3 is turned off under control of the low-level fourth control signal sc4, the fourth transistor T4 is turned off under control of the low-level of the second control signal sc2, the fifth transistor T5 is turned off under control of the low-level light emission control signal em, and the sixth transistor T6 is turned off under control of the low-level first control signal sc1. The turned-on second transistor T2 provides the data voltage signal from the data signal terminal DA to the gate of the driving transistor T0, so the voltage at the gate of the driving transistor T0 is Vda. The first capacitor C1 keeps the voltage difference between the second terminal and the gate of the driving transistor T0 stable. The second capacitor C2 keeps the voltage difference between the second terminal of the driving transistor T0 and the first power terminal VDD stable. As a result, the voltage at the second terminal of the driving transistor T0 changes from Vof−Vth to

$$Vof - Vth + \frac{C 1}{C 1 + C 2} * ( Vda - Vof ) .$$

When considering the parasitic capacitance Coled of the light-emitting device L, the voltage at the second terminal of the driving transistor T0 is

$$Vof - Vth + \frac{C 1}{C 1 + C 2 + Coled} * ( Vda - Vof ) .$$

In the light emission phase F4, the second transistor T2 is turned off under control of the low-level third control signal sc3, the third transistor T3 is turned off under control of the low-level fourth control signal sc4, the fourth transistor T4 is turned off under control of the low-level second control signal sc2, the fifth transistor T5 is turned on under control of the high-level light emission control signal em, and the sixth transistor T6 is turned on under control of the high-level first control signal sc1. The turned-on fifth transistor T5 provides the signal from the first power terminal VDD to the first terminal of the driving transistor T0, causing the driving transistor T0 to generate the driving current. The turned-on sixth transistor T6 provides the driving current from the driving transistor T0 to the light-emitting device L, charging the anode of the light-emitting device L until it stabilizes its emission. The voltage difference Vgs between the gate and the source of the driving transistor T0 is

$$\frac{C 2}{C 1 + C 2} * ( Vda - Vof ) + Vth .$$

The driving transistor T0 operates in the saturation region, and the driving current it generates is

$$I = \frac{1}{2} * k * {[ \frac{C 2}{C 1 + C 2} * ( Vda - Vof ) ]}^{2} , where k = μ {C}_{ox} \frac{W}{L} .$$

When considering the parasitic capacitance Coled of the light-emitting device L, the driving current becomes

$$I = \frac{1}{2} * k * {[ \frac{C 2 + Coled}{C 1 + C 2 + Coled} * ( Vda - Vof ) ]}^{2} .$$

It should be noted that in the light emission phase F4, if the turn-on moment of the sixth transistor T6 is earlier than the turned-on moment of the fifth transistor T5, there will be coupling based on the parasitic capacitance Coled of the light-emitting device L at the second terminal of the driving transistor T0. If there are differences in the capacitance values of the parasitic capacitances Coled, it will lead to slight brightness variations on the display panel, affecting the display effect and degrading the display quality.

In embodiments of the disclosure, as shown in FIG. 10, by making the start moment of the first control signal sc1 the same as the start moment of the light emission control signal em in the light emission phase F4, and turning on the sixth transistor T6 and the fifth transistor T5 simultaneously, coupling based on the parasitic capacitance Coled of the light-emitting device L at the second electrode of the driving transistor T0 can be avoided. This improves the brightness uniformity and image quality uniformity of the display panel, enhancing the display effect.

Furthermore, in embodiments of the disclosure, as shown in FIG. 9, by making the start moment of the first control signal sc1 later than the start moment of the light emission control signal em in the light emission phase F4, the turned-on moment of the sixth transistor T6 is later than the turned-on moment of the fifth transistor T5. For example, the sixth transistor T6 can be controlled to be turned on after the voltage of the light emission control signal has gradually risen to more than 80% of its high-level voltage (e.g., 85%, 90%, 95%, etc.). This also avoids coupling based on the parasitic capacitance Coled of the light-emitting device L at the second terminal of the driving transistor T0, and compared to the simultaneous turning on of the sixth transistor T6 and the fifth transistor T5, this further improves the brightness uniformity and image quality uniformity of the display panel, enhancing the display effect.

Based on the same disclosure concept, the embodiments also provide a display apparatus, including the pixel circuit provided in the embodiments. The principle of the display apparatus solving the problem is similar to that of the above display panel. Therefore, the implementation of the display apparatus can refer to the implementations of the pixel circuit mentioned above, and redundant parts are not elaborated here.

In specific implementations, the display apparatus in the embodiments of the disclosure can be: a mobile phone, tablet, television, monitor, laptop, digital photo frame, navigation device, or any product or component with a display function. Other essential components of the display apparatus should be understood to be included in the display apparatus for those skilled in the art, which are not further elaborated here and should not be construed as limiting the scope of the disclosure.

Although the preferred embodiments of the disclosure have been described, those skilled in the art can make further changes and modifications to these embodiments once they understand the basic creative concept. Therefore, the appended claims are intended to be interpreted as including the preferred embodiments and all changes and modifications falling within the scope of the disclosure. Obviously, those skilled in the art can make various alterations and modifications to the disclosed embodiments without departing from the spirit and scope of the disclosure. Thus, if these modifications and variations of the disclosed embodiments fall within the scope of the claims and their equivalents, the disclosure is intended to cover these modifications and variations.

1. A pixel circuit, comprising:
a light-emitting device;
a driving transistor configured to generate, based on a data voltage signal, a driving current for driving the light-emitting device to emit light;
a driving control circuit, coupled to the driving transistor and configured to:
provide the data voltage signal to a gate of the driving transistor; and
in response to a signal from a light emission control signal terminal being at an active level, cause the driving transistor to generate the driving current;
a conduction control circuit, wherein the driving transistor is coupled to the light-emitting device via the conduction control circuit, and the conduction control circuit is configured to provide the driving current from the driving transistor to the light-emitting device in response to a signal from a first control signal terminal being at an active level;
wherein, a duration of the active level of the signal from the first control signal terminal is shorter than a duration of the active level of the signal from the light emission control signal terminal.

2. The pixel circuit according to claim 1, wherein
the driving control circuit is configured to: in a light emission phase, in response to the signal from the light emission control signal terminal being at the active level, cause the driving transistor to generate the driving current;
the conduction control circuit is configured to: in the light emission phase, in response to the signal from the first control signal terminal being at the active level, provide the driving current from the driving transistor to the light-emitting device;
wherein in the light emission phase, a start moment of the signal from the first control signal terminal being at the active level is later than a start moment of the signal from the light emission control signal terminal being at the active level; or
a start moment of the signal from the first control signal terminal being at the active level is same as a start moment of the signal from the light emission control signal terminal being at the active level.

3. The pixel circuit according to claim 1, wherein the driving control circuit comprises:
a reset circuit, coupled to a second terminal of the driving transistor, and configured to provide a signal from a first reference voltage signal terminal to the second terminal of the driving transistor in response to a signal from a second control signal terminal;
a data writing circuit, coupled to the gate of the driving transistor, and configured to provide a reference voltage signal from a data signal terminal and the data voltage signal from the data signal terminal to the gate of the driving transistor, respectively;
a light emission control circuit, coupled to a first terminal of the driving transistor, and configured to provide a signal from a first power supply terminal to the first terminal of the driving transistor in response to the signal from the light emission control signal terminal;
a first control circuit, coupled to the gate and the second terminal of the driving transistor, and configured to keep a voltage difference between the second terminal and the gate of the driving transistor stable; and
a second control circuit, coupled to the first power supply terminal and the second terminal of the driving transistor, and configured to keep a voltage difference between the second terminal of the driving transistor and the first power supply terminal stable.

4. The pixel circuit according to claim 3, wherein the data writing circuit is further configured to:
in response to a signal from a third control signal terminal, first provide the reference voltage signal from the data signal terminal to the gate of the driving transistor and then provide the data voltage signal from the data signal terminal to the gate of the driving transistor.

5. The pixel circuit according to claim 4, wherein the data writing circuit comprises a first transistor;
wherein a gate of the first transistor is coupled to the third control signal terminal, a first terminal of the first transistor is coupled to the data signal terminal, and a second terminal of the first transistor is coupled to the gate of the driving transistor.

6. The pixel circuit according to claim 3, wherein the data writing circuit is further configured to:
provide the data voltage signal from the data signal terminal to the gate of the driving transistor in response to a signal from a third control signal terminal; and
provide the reference voltage signal from the data signal terminal to the gate of the driving transistor in response to a signal from a fourth control signal terminal.

7. The pixel circuit according to claim 6, wherein the data writing circuit comprises a second transistor and a third transistor;
wherein
a gate of the second transistor is coupled to the third control signal terminal, a first terminal of the second transistor is coupled to the data signal terminal, and a second terminal of the second transistor is coupled to the gate of the driving transistor; and
a gate of the third transistor is coupled to the fourth control signal terminal, a first terminal of the third transistor is coupled to the data signal terminal, and a second terminal of the third transistor is coupled to the gate of the driving transistor.

8. The pixel circuit according to claim 3, wherein the reset circuit comprises a fourth transistor;
wherein a gate of the fourth transistor is coupled to the second control signal terminal, a first terminal of the fourth transistor is coupled to the second terminal of the driving transistor, and a second terminal of the fourth transistor is coupled to the first reference voltage signal terminal.

9. The pixel circuit according to claim 3, wherein the light emission control circuit comprises a fifth transistor;
wherein a gate of the fifth transistor is coupled to the light emission control signal terminal, a first terminal of the fifth transistor is coupled to the first power supply terminal, and a second terminal of the fifth transistor is coupled to the first terminal of the driving transistor.

10. The pixel circuit according to claim 3, wherein the first control circuit comprises a first capacitor;
wherein a first electrode of the first capacitor is coupled to the gate of the driving transistor, and a second electrode of the first capacitor is coupled to the second terminal of the driving transistor.

11. The pixel circuit according to claim 3, wherein the second control circuit comprises a second capacitor;
wherein a first electrode of the second capacitor is coupled to the first power supply terminal, and a second electrode of the second capacitor is coupled to the second terminal of the driving transistor.

12. The pixel circuit according to claim 1, wherein the conduction control circuit comprises a sixth transistor;
wherein a gate of the sixth transistor is coupled to the first control signal terminal, a first terminal of the sixth transistor is coupled to a second terminal of the driving transistor, and a second terminal of the sixth transistor is coupled to the light-emitting device.

13. The pixel circuit according to claim 1, wherein the driving transistor is a single-gate transistor.

14. The pixel circuit according to claim 3, wherein the driving transistor is a dual-gate transistor, and the driving transistor comprises a top gate and a bottom gate;
wherein the top gate of the driving transistor is coupled to the data writing circuit, and the bottom gate of the driving transistor is coupled to the second terminal of the driving transistor.

15. A display apparatus, comprising the pixel circuit according to claim 1.

16. A driving method for the pixel circuit according to claim 1, comprises:
in a data writing phase:
providing, by the driving control circuit, the data voltage signal to the gate of the driving transistor;
and
in a light emission phase:
in response to the signal from the light emission control signal terminal being at the active level, causing, by the driving control circuit, the driving transistor to generate the driving current; and
in response to the signal from the first control signal terminal being at the active level, providing, by the conduction control circuit, the driving current from the driving transistor to the light-emitting device.
